(19) United States
(12) Patent Application Publication
(10) Pub. No.: US 2013/0290193 A1
(43) Pub. Date: Oct. 31, 2013

(54) SYSTEM AND METHOD OF TRAFFIC DATA COLLECTION AND MANAGEMENT

(71) Applicant: JAMES HARMEN BEEKSMA, NORTH YORK (CA)

(72) Inventor: JAMES HARMEN BEEKSMA, NORTH YORK (CA)

(21) Appl. No.: 13/667,728

(22) Filed: Nov. 2, 2012

Related U.S. Application Data
(60) Provisional application No. 61/624,274, filed on Apr. 14, 2012.
(60) Provisional application No. 61/555,210, filed on Nov. 3, 2011.

(51) Int. Cl. G06Q 10/10

(52) U.S. Cl. CPC G06Q 10/103
USPC 705/301

(57) ABSTRACT

A system and method for collecting and managing vehicle and pedestrian traffic data. An electronic device may be used to collect traffic data. The system has a processor, a communication subsystem and a memory for storing traffic data. The processor is configured to receive traffic data from the electronic device through a communications network, store the received traffic data in a database, and generate for display on a graphical interface screen a data management portal providing a web service to view traffic data collection project jobs, view project traffic data and sell project traffic data.

### CROSS-REFERENCE TO RELATED APPLICATIONS

The instant application claims priority from U.S. Provisional Patent Application Ser. No. 61/555,210 filed Nov. 3, 2011 and claims priority from U.S. Provisional Patent Application Ser. No. 61/624,274 filed on Apr. 14, 2012, the disclosure of these applications is incorporated herein by reference.

### TECHNICAL FIELD

The present invention relates to traffic data collection and management. More particularly, the invention relates to a system and method of collecting, managing and exchanging traffic data.

### BACKGROUND OF THE INVENTION

The movement of vehicles is recorded using various types of equipment. This information is collected and used, for example, in the planning, design and operation of public transportation infrastructure.

FIG. 1 illustrates an example conventional traffic data collection and management system 100. Conventional methods of collecting traffic data include localized data collection services using equipment 102 that does not have the functionality to wirelessly transfer the data to a management server 104 or software. As well, conventional traffic data collection processes produce non-auditable data, require excessive cycle time between collection and analysis, and demand an infrastructure of management and supervision. The conventional methods of traffic data collection limits the market reach of services to the daily driving distance abilities of supervisors and survey contractors. As well, conventional methods of collection and storage do not permit providers of data collection equipment and data management software to access the majority of industry revenue.

In some conventional solutions, temporary staff is organized to carry out manual data collection surveys, which is time consuming to find and train leading to higher costs and using alternative imprecise data recording methods. As well, in some conventional methods transferring data collected from existing industry traffic data collection equipment 102 to data management systems 100 requires a direct wired connection. This increases processing costs and limits service area distances as existing equipment must be physically transported to and from the survey location. Raw data is then transferred to a computer, summarized, and stored in a database. The data may also be summarized on an illustrative map.

Another problem is that traffic data management systems and equipment are industry specific which makes the proportional development costs higher for the end user. Manual traffic collection equipment is not owned by the temporary survey contractors collecting the data as the equipment only has industry specific functionality. As a result, the equipment costs are high due to a narrow market. For example, the equipment is made with industrial grade shell materials for durability to prevent damage by survey contractors.

Additionally, existing manual traffic data collection survey equipment do not possess GPS time and location data stamping capabilities, which then requires physical supervision to reduce occurrences of fraudulent practices. As constant physical supervision is not economical, data reliability is compromised due to the availability for fraudulent practices.

As well, in present methods of traffic data collection, data from intersection surveys that require more than one survey contractor need to be transferred from each survey contractor's device into separate data files that must be manually merged together, which results in increased processing times.

In conventional traffic data collection methods, monetary resources allocated to labour and management of labour to conduct data collection surveys is overwhelmingly greater than all the resources allocated to equipment and data management systems. Since data collection services, equipment and data management systems are not fully integrated, it limits the available resources that could be directed towards the advancement of equipment and data management technology. This has limited the technology advancement in the traffic data collection industry.

Finally, the industry has no public market place to search, purchase and sell existing traffic data collected from both public and private industry agencies.

### SUMMARY OF THE INVENTION

The present application provides a system and method that integrates the entire process of traffic data collection, management, warehousing as well as providing a resale marketplace for traffic data. The system utilizes the internet, wireless data transmission and mobile devices, such as touch screen mobile devices.

The system facilitates a method of exchanging traffic data for compensation between employers (for example public and private agencies) willing to pay for traffic survey data and independent survey contractors who will collect data for a fee using their touch screen mobile device. In some example embodiments, the system provides an online auction environment for contractors to compete for the awarding rights of the employer's data collection project jobs. The contractor's device may electronically transmit the collected data to the online traffic data management and e-commerce resale system. The system also facilitates the process of uploading data from all automatic traffic data recording devices (for example, directional vehicle tube counting equipment) using a mobile device to the online traffic data management and ecommerce resale system for a processing fee.

The following describes the method and system of the present application that utilize existing Internet, mobile equipment and wireless data transmission technologies. Overall, the system and method of the present application integrates three existing independent market verticals being data collection equipment, data management software, data collection services into one centralized service. The streamlined solution will enable industry clients to lower their costs and improve their efficiency while significantly increasing the integrity and timeliness of their data collection efforts.

According to the present application, there is provided a method for data management. The method includes generating, from a server, for display on a graphical interface screen a data management portal providing a web service to view traffic data collection project jobs, view project traffic data, and sell project traffic data; sending, at the server, traffic data collection project setup information to an electronic device via a communication network; receiving, at the server, traffic data from the electronic device via the communication network; and storing the received traffic data in a database.

As well, according to the present application, there is provided a computer system that includes a processor; a memory for storing project data; and a communications subsystem. The processor is configured to: generate for display on a graphical interface screen a data management portal providing a web service to view traffic data collection project jobs, view project traffic data, and sell project traffic data; send traffic data collection project setup information to an electronic device via a communication network; receive traffic data from the electronic device via the communication network; and store the received traffic data in a database.

Also, according to the present application, there is provided an electronic device that includes a processor; a memory for storing project data; and a communications subsystem. The processor is configured to: generate, on a web browser, for display on a graphical interface screen a data management portal providing a web service to search traffic data collection project jobs, bid on traffic data collection project jobs, and receive payment for completed traffic data collection project jobs; receive, from a computer system, data collection setup information for a data collection application via a communication network; and transmit traffic data to the computer system via the communication network.

Additionally, according to the present application, there is provided a non-transitory computer readable medium having instructions stored thereon, which when executed by a processor for facilitating data management, the processor performs the method of data management described in the application.

### BRIEF DESCRIPTION OF THE DRAWINGS

Reference is now made to the following drawings:

FIG. 1 illustrates a prior art system for collecting and managing traffic data;

FIG. 2 illustrates a traffic data collection system, according to an embodiment of the present application;

FIG. 2A illustrates the traffic data collection system, according to an embodiment of the present application;

FIG. 3A illustrates a site map for the data management web portal, according to one embodiment of the present application;

FIG. 3B illustrates a site map for the employer portal and contractor portal, according to one embodiment of the present application;

FIG. 4 illustrates the data management web portal, according to an embodiment of the present application;

FIG. 5 illustrates a public registration process for accessing the data management web portal, according to an embodiment of the present application;

FIG. 6 illustrates a full registration process for full access to the data management web portal, according to an embodiment of the present application;

FIG. 7 illustrates a data project process from the employer's perspective, according to an embodiment of the present application;

FIG. 8 illustrates a data project process from the survey contractor's perspective, according to an embodiment of the present application;

FIG. 9 illustrates a data management web portal graphical user interface (GUI) screen, according to an embodiment of the present application;

FIG. 10 illustrates a mobile device application GUI screen, according to an embodiment of the present application;

FIG. 11 illustrates a data information GUI screen, according to an embodiment of the present application;

FIG. 12 illustrates a project summary GUI screen, according to an embodiment of the present application;

FIG. 13 illustrates a detailed project information GUI screen, according to an embodiment of the present application;

FIG. 14 illustrates a location information GUI screen on a mobile device, according to an embodiment of the present application; and,

FIG. 15 illustrates a marketplace GUI screen, according to an embodiment of the present application.

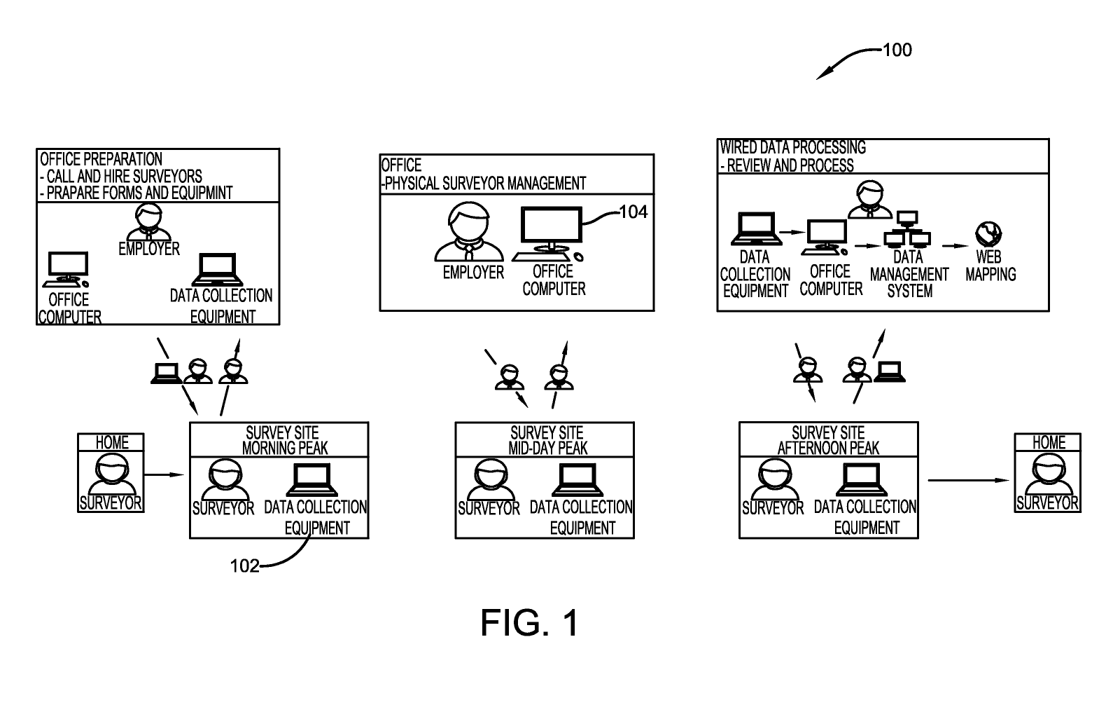

### DETAILED DESCRIPTION OF EXAMPLE EMBODIMENTS

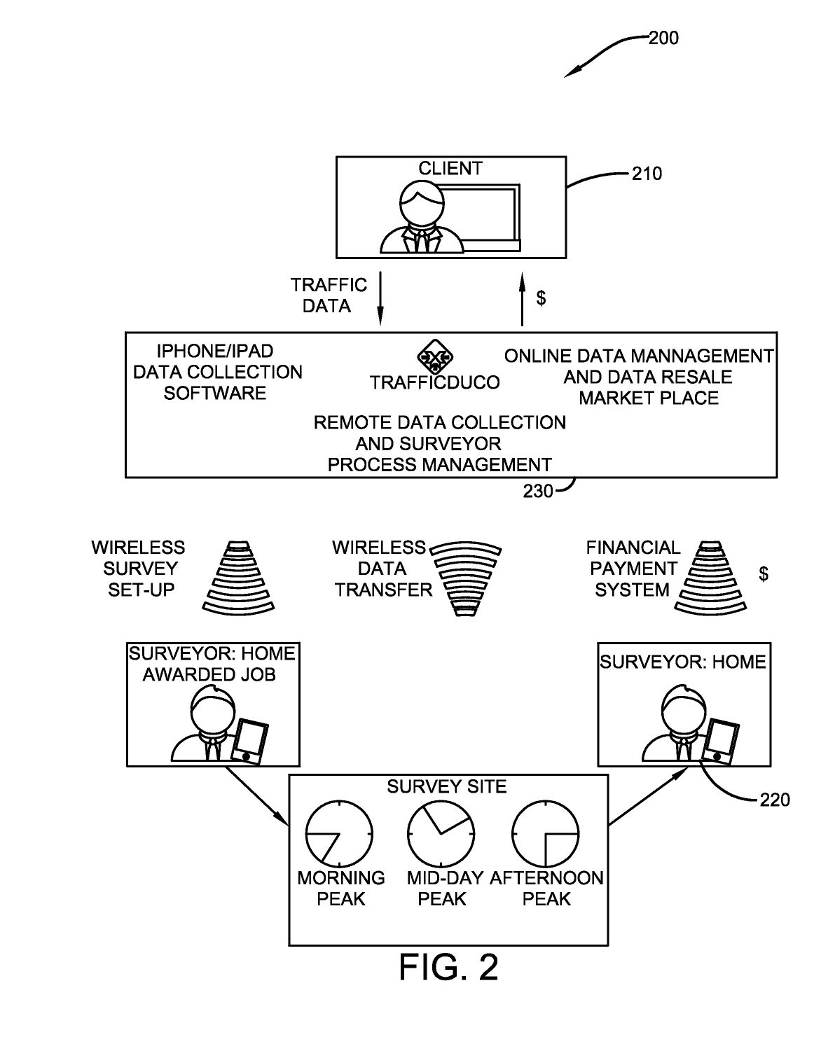

Example embodiments of the present application provide a system and method for collecting, storing, managing and selling traffic data. The system 200 of FIG. 2 facilitates the entire process of manual traffic data collection projects. The system 200 allows public and private organizations or individuals (known herein as ‘employers’) to easily search for existing traffic data or to competitively procure traffic data through a data management web portal. As well, the system 200 facilitates individuals (known herein as ‘survey contractors’) to work in the area of traffic data collection. For example, the system 200 may provide the contractor with online education tutorials, tests and certifications to conduct data collection project jobs. In some example embodiments, internal staff may conduct surveys and complete the data collection project jobs.

An employer may be a public or private agency or an individual willing to pay for traffic survey data. A survey contractor may be an independent individual user who will collect traffic survey data for a fee. A surveyor device 220 may be a mobile electronic device that has touch screen, wireless data transfer capabilities (for example, Wi-Fi, 3G, 4G etc.) and GPS capabilities (for example, an Apple™ iPhone or iPad, an Android™ phone, etc). A project may be a data collection survey that has a specific location, time periods and survey type. The project may require multiple survey contractors, and therefore may be separated as project jobs within the same project. Project jobs may be a data collection job that is assigned to one survey contractor to perform a specific a data collection job within a project.

The surveys may be related to traffic, transportation and transit operations. The results of the surveys may be used in the planning, design and operations of transportation and transit systems. Traffic data, which may also be referred to as transportation data, includes statistics on vehicle and pedestrian movements. The vehicular traffic may include motorized vehicles (e.g., cars, buses, trains) and may include non-motorized vehicles (e.g., bicycles). As well, the traffic data may include pedestrian traffic movements, such as individuals walking through an intersection. The traffic survey recordings may include metrics such as volume of traffic, speed, type of traffic, vehicle spacing, vehicle queuing, acceleration, travel delay, travel time, saturation to measure capacity, origin-destination, roadside surveys, collision report, transit frequency, occupancy, etc. Also, traffic data may be documented in the form of a video recording, audio recording, photograph, word processing document, spreadsheet document (for example a comma-separated values (csv) file), etc.

FIG. 2 illustrates an example diagram of system 200 for traffic data collection and management. For example, the system 200 may be used as a web portal for access by an employer device 210 and a surveyor device 220. As shown, a server system 230 may communicate with the employer device 210 and the surveyor device 220 over a communication network 205, such as a wireless network or the Internet. As well, the communication network 205 may be a cellular network.

The server system 230 may be configured as a web server which generates graphical user interface (GUI) screens for display on the employer device 210 and the surveyor device 220. As shown in FIG. 2, in some example embodiments, the server system 230 may include one or more processors 232, at least a memory 234 for storing system software and databases for traffic data, and at least a communications subsystem 236.

The memory 234 of the server system 230 may include user information, which can include user information along with associated access rights. For example, only certified survey contractors may have access to a project auction web page. The memory 234 may also include a database of projects, the projects containing associated information such as traffic data, location information, time information, survey contractor identification.

The surveyor device 220 may include one or more client applications 222. In some example embodiments, the surveyor device may include a controller 224 such as a microprocessor, which controls the overall operation of the surveyor device 220. The controller 224 interacts with other device components such as memory 226, and system software 227 stored in the memory 226 for executing the applications 228, input/output subsystems 229 (e.g., a keyboard, touchpad, scrollwheel, and/or a display) and a communications subsystem 223. A power source 221 powers the surveyor device 220. As well, the surveyor device 220 may include a global positioning system (GPS), as understood in the art, for identifying the location of the surveyor device 220.

Referring still to FIG. 2, in some example embodiments, the surveyor device 220 may be configured with a web browser which is used to access a web site or web portal of the server system 230, for example to bid on a project. The web browser is configured to render the graphical user interface screens onto the display of the surveyor device 220, based on the information received from the server system 230 or from resident information. The surveyor device 220 may be, for example, a tablet computer, mobile phone, or a portable electronic device. Some example embodiments may include the use of a dedicated installed application or “app” on the surveyor device 220. The surveyor device 220 functions as a manual traffic data collection device and is used to record and collect traffic data. The app may facilitate traffic data collection and completion of traffic data surveys. Accordingly, specialized equipment that only functions for the purpose of data collection is not required in the present system.

The employer device 210 may include one or more client applications 212. In some example embodiments, the employer device may include a controller 214 such as a microprocessor, which controls the overall operation of the employer device 210. The controller 214 interacts with other device components such as memory 216, and system software 217 stored in the memory 216 for executing the applications 218, input/output subsystems 219 (e.g., a keyboard, touchpad, scrollwheel, and/or a display) and a communications subsystem 213. A power source 221 powers the employer device 210.

Referring still to FIG. 2, in some example embodiments, the employer device 210 may be configured with a web browser which is used to access a web site or web portal of the server system 230, to post a project, access traffic data and/or sell traffic data. The web browser is configured to render the graphical user interface screens onto the display of the employer device 210, based on the information received from the server system 230 or from resident information. The employer device 210 may be, for example, a tablet computer, mobile phone, portable electronic device or a general purpose device such as a personal computer. Some example embodiments may include the use of a dedicated installed application or “app” on the employer device 210.

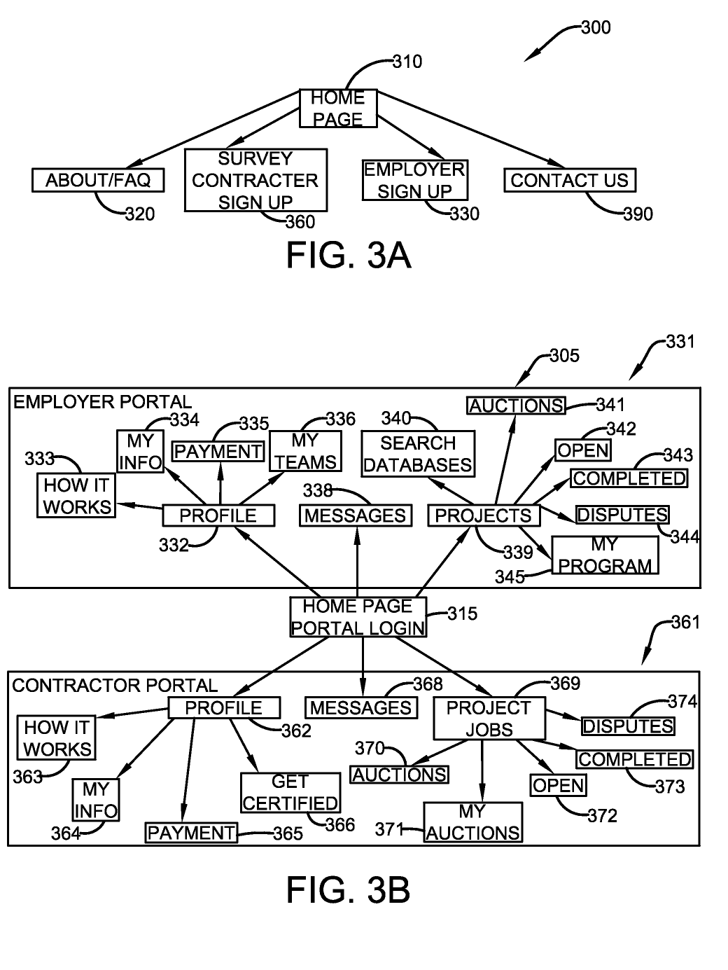

FIG. 4 illustrates the server system 230, according to an example embodiment of the present application. The server system 230 may provide a cloud-based web service in the form of a data management web portal 400. The data management web portal 400 allows the administration, management of project scope changes, communication, dispute resolution, and financial transactions and reporting between the employers and survey contractors. The data management web portal 400 may include a registration module 410, a data module 420, a payment module 430 and a software module 440. The data management web portal 400 may be developed, for example, using open source Linux, Apache, MySQL and PHP software and programming languages.

The registration module 410 facilitates the public (limited) and full registration process depending on the type of user (employer or survey contractor) entering from the data management web portal 400. The registration module 410 allows for both employers and survey contractors to first register for a limited public subscription to review the service with limited functions until they register to receive a full subscription to access the full functionality of the data management web portal 400.

The data module 420 provides a repository where all traffic data collected is stored for future use by either all employers wishing to purchase the data or held privately by employer owner of the data. The data module 420 facilitates the storage of auction, open and completed project jobs. It may also facilitate communication between employers and survey contractors for ongoing jobs. The traffic data may be searched and accessed through the data management web portal 400. Data collected by the surveyor's device 220 may be transmitted to the data module 420 via the communications network 205.

In one embodiment, the data module 420 automatically merges the received traffic data from multiple surveyor devices 220 into a single report file, when multiple surveyors are required for a busy intersection traffic survey. For example, some traffic surveys require multiple surveyors (devices) and the data management web portal 400 may merge the received traffic data from multiple surveyor devices to produce a single data collection project. As the data on each surveyor device 200 is dependent on one another, missing traffic information on one leg of an intersection makes the entire survey useless. The data management web portal 400 automatically merges the received traffic data from multiple surveyor devices, improving processing times.

Employers can edit, confirm details and summarize the collected data through the data management web portal 400. As well, the data module 420 stores information regarding data collection project jobs that are posted through an auction web page. The online auction permits certified survey contractors to compete for the rights to be awarded this job (for example, by bidding the lowest hourly rate) during the auction period. The data module 420 also facilitates the management of processing collected traffic data from existing automatic traffic data recording equipment. In some embodiments, a mobile device, such as the surveyor's device 220 may be used to connect and read raw data from automatic data collection equipment (not shown) using loaded software application received from software module 440. The data module 420 also facilitates the data management of completed projects, such as the storage, online geomapping and retrieval of traffic data. The data module 420 may also record the location of a surveyor device 220 during the survey through the surveyor device's 220 existing GPS and time stamping capabilities.

The payment module 430 provides access to a secure payment gateway to complete transactions within the data management web portal 400. For example, the payment module 430 facilitates a financial transactions performed on the system 200, such as payment of the full registration fees or payment from an employer to a survey contractor after completion of a project job. The payment module 430 also facilitates a traffic data resale exchange, which is an online traffic data ecommerce marketplace for employers to market and sell their project traffic data to potential buyers within the data management web portal 400. The payment module 430 also provides automatic receipting of financial transactions performed on the data management web portal 400.

The software module 440 provides the software and setup information to provide the surveyor device 220 with applications to collect and transmit traffic data. For example, once awarded a project job, the software module 440 may transmit project setup data to the surveyor device 220 prior to the survey date, which eliminates existing surveyor device setup errors. As well, the software module 440 may provide the surveyor device 220 software applications to be installed prior to the survey date to facilitate the recording of manual observation events of the specific survey.

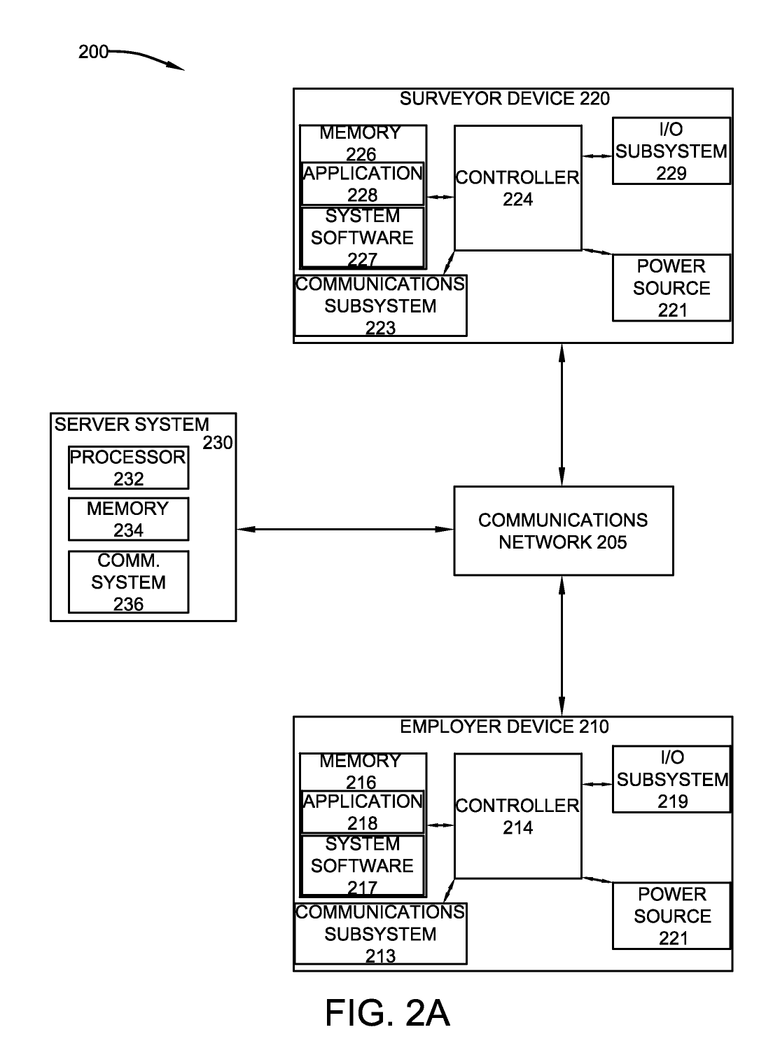

Reference is now made to FIG. 3A, which shows a sitemap 300 for the data management web portal 400 of the system 200, in accordance with an example embodiment. The home page 310 of the data management web portal 400 provides access to four web pages: About/FAQ 320 page about the data management web portal, survey contractor sign up 360 page, employer sign up 330 page and contact us 390 page containing service contact information.

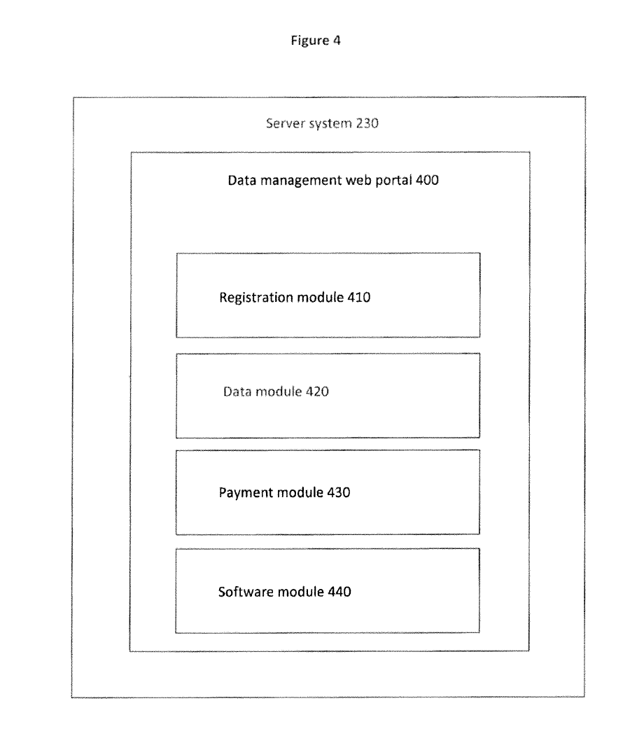

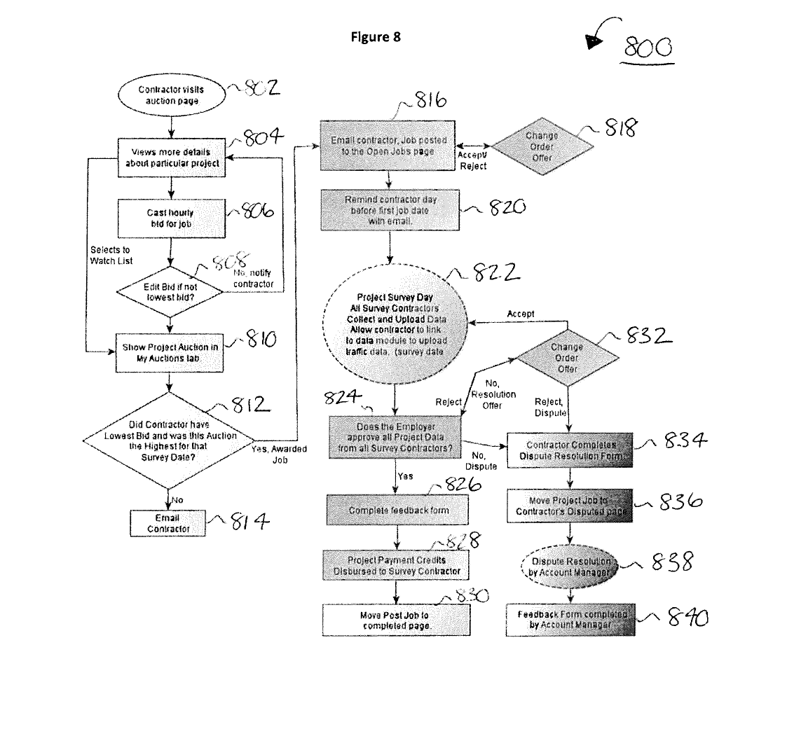

FIG. 5 illustrates a public registration process 500 for an employer user and a survey contractor user according to an embodiment of the present application. The user first visits the home page 310 of the data management web portal 400 (block 502) and then selects the user type: either employer 330 or survey contractor 360 (block 504). FIG. 9 illustrates an example GUI home page screen 900 where a user may begin the initial public registration process. The screen 900 provides a get started button 902 for an employer and a get started button 904 for a survey contractor. If the user is an employer, the user is directed to an employer registration/sign up page where the user may submit basic profile information (block 506). If the user is a survey contractor, the user is directed to a survey contractor registration/sign up page where the user may submit basic profile information (block 508). Once the user profile information is submitted, the information is stored in a user profile database (block 510) and an email is sent to the user providing login instructions and a login password, such as a temporary password (blocks 512, 518). The user may then log into their limited access account from the GUI home page screen 900 of the data management web portal 400 at the login area 906 (blocks 514, 520). The user at this time has limited access to the functionality provided by the data management web portal 400. The employer user may complete the registration with payment of a fee in order to receive a full employer subscription having full access to the data management web portal 400 (block 516). The employer may submit a payment through the payment module 440, purchase prepaid credits required to post data collection projects, and may negotiate a subscription plan with an account manager of the web portal. Similarly, the survey contractor may complete registration with payment of a fee in order to receive a full survey contractor subscription having full access to the data management web portal 400 (block 522).

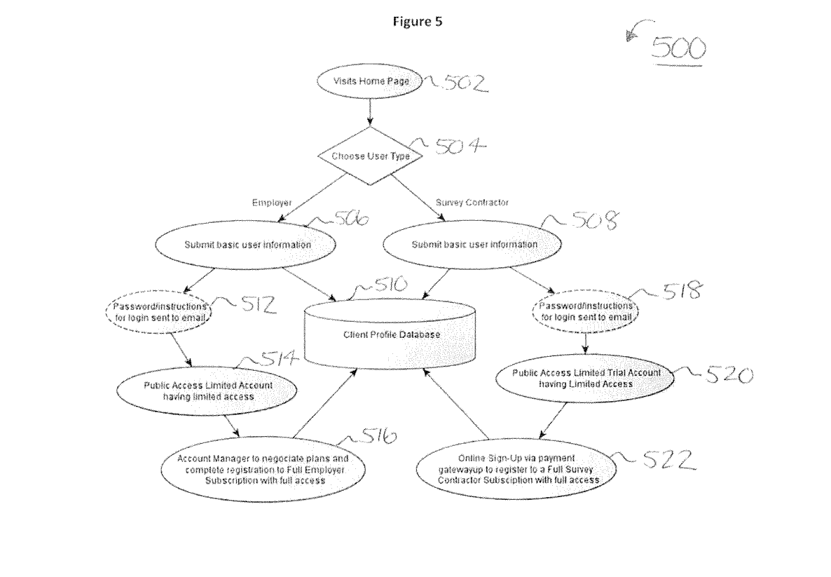

FIG. 6 illustrates a full registration process 600 for both an employer user and a survey contractor according to an embodiment of the present application. After completing the public registration process and receiving login instructions and a temporary password (for example, blocks 512, 518), the user may log into the data management web portal 400 using their email address and the temporary password (block 602). If the user is logging in for the first time (block 604), then the user is presented with a how it works video tutorial on the how it works 333, 363 web page (blocks 606, 608). If the user has previously logged in, or after the user is presented with the how it works tutorial, the user is then presented with the option of registering for a full subscription (blocks 610, 622).

If the employer user does not choose to register for a full subscription, then the employer is presented with the search database 340 web page, where the employer may search for and may purchase existing data (blocks 618, 620). However, with the limited subscription, the employer may not post any project jobs. If the employer user chooses to register for a full subscription, the registration may be completed online or with an account manager (block 612). Once the payment for the full subscription is processed (block 614), the employer user may be presented with an employer portal 331.

If the survey contractor user does not choose to register for a full subscription, then the survey contractor is presented with auctions 370 web page, where the survey contractor may search for job auctions (block 630). However, with the limited subscription, the survey contractor may not bid on the job auctions. If the survey contractor user chooses to register for a full subscription, the registration may be completed through an online form (block 624). Once the payment for the full subscription is processed (block 626), the survey contractor is presented with a get certified 366 web page and has full access to a survey contractor portal 361. The contractor however will have to be certified prior to submitting bids on project jobs.

FIG. 3B illustrates a sitemap 305 of the survey contractor portal 361 and the employer portal 331, in accordance with an example embodiment. The data management web portal 400, survey contractor portal 361 and employer portal 331 may be hosted on the server system 230. A full registration is required for a user to access all the web pages included in the survey contractor portal 361 or the employer portal 331. The employer and survey contractor log into the portals 331,361 through the home page portal login 315.

The employer portal 331, as shown in FIG. 3B, has a profile 332 web page, a messages 338 web page and a project jobs 339 web page. Through the messages web page 338, the employer may communicate with the survey contractors and receive system 200 messages.

In some embodiments the employer portal 331 has a marketplace web page (not shown), separate from the project 339 web page, which facilitates the search and purchasing of existing data collection projects. As well, in some embodiments, the employer portal 331 has a team web page (not shown) which shows projects that are posted to internal surveyor staff to be accepted.

From the profile 332 web page, an employer may access a how it works 333 web page, a my info 334 web page, a payment 335 web page, a my teams 336 web page. The how it works 333 web page provides information regarding the data management web portal 400, such as a video tutorial. As well, from the profile 332 web page, an employer may view and edit their profile on the my info 334 page. As well, the employer may purchase credits, edit payment information, and download account reports on the payment 335 web page, and manage their data collection user teams on the my teams 336 web page.

The project 339 web page facilitates the existing project data searches, initial data collection project setup, project auctions, open projects, completed projects, disputed projects and program projects (automatic and manual). In one embodiment, after logging in, the first page the employer may view is the project 339 web page.

From the project jobs 339 web page, the employer may access a search database 340 web page, an auctions 341 web page, an open 342 web page, a completed 343 web page, a disputes 344 web page, and a my program 345 web page. The search database 340 web page contains all finished projects in the entire database. From the search database 340 web page, the employer may search and purchase existing data collection projects. For example, for each project, the project location, survey type, dates, time periods and resale price may be viewable using Google Maps API interface.

The auctions 341 web page contains all projects that the employer has posted as live auctions at the present time. On the auctions 341 web page, the employer may post a new data collection project for auction and identify the type of survey contractor (team user, preferred contractors, all contractors) required. As well, from this page, the employer may view auction details and if there are no survey contractor bids, can edit the auction to change dates and increase starting bids. The data collection projects on the auction web page 341 will be open to certified survey contractors (who wish to earn money collecting data) through the data management web portal 400, and the survey contractors may bid an hourly rate to conduct the data collection project job.

The open 342 web page contains project jobs which have been awarded to a survey contractor but that have not yet been completed. On the open 342 web page, the employer may request a change order for additional data (i.e. pictures etc), change dates, times, classifications and request recounts with compensation. Additionally, the employer may send and receive messages from a contractor, and approve or dispute each project job within the project. Traffic data collected by the survey contractors is transmitted from the surveyor's device 220 via the communications network 205 to the data module 420. The employer can view a verification page containing such items as maps with GPS markings, graphs and charts of raw data statistics on the open 342 web page and approve each project job, thereby completing the transaction with the survey contractor. Information regarding completed projects is located on the completed 343 web page. If the data collected is not approved, the employer can submit a project change orders (i.e. recount) or proceed to the dispute resolution process on dispute web page 344 to submit a dispute request through the disputes 344 web page and/or repost the project job. The survey contractor will also be able to dispute any project jobs if they cannot resolve issues with an employer.

The completed 343 web page contains all projects that the employer started and completed, and all data that the employer has purchased from the database. On the completed 343 web page, the employer may view details, repost project and download data of their completed and purchased projects. As well, from the project completed 443 web page, the employer can download the completed project data, set a price to resell data to other employers, and store the data in the data module 410. Also, the employer can view, edit, confirm, set a resale price and market completed project data from automatic traffic recording equipment that has been transmitted wirelessly at the survey location from a touch screen mobile device and through the communication network 205 to the data module 420. Additionally, the employer may provide feedback on the survey contractor and add the survey contractor to a preferred contractor list, after a project is completed.

The disputed 344 web page contains all projects which are currently under temporary dispute. From the disputes 344 web page, the employer may view details of their project job disputes, repost project jobs or terminate project jobs.

Finally, the my program 345 web page contains all projects and automatic traffic recording data as part of an employer's data collection program (e.g., an annual or semi-annual data collection program). On the my program 345 web page, the employer may add projects and automatic data collection locations and set up reoccurring data collection projects to facilitate the management of an employer's annual data collection program. As well, the employer may view, edit, store, set resale price and geomap collected data received from an automatic data collection device.

As shown in FIG. 3B, the contractor portal 361 has a profile 362 web page, a messages 368 web page and a project jobs 369 web page. Through the messages web page 338, the survey contractor may communicate with the employer, other contractors working on the same project, and receive system 200 messages.

From the profile 362 web page, a contractor may access a how it works 363 web page, a my info 364 web page, a payment 365 web page, and a get certified 366 web page. The contractor may view and make limited edits to their profile on the profile 362 web page, and on the payment 365 web page edit payment information and download account reports.

The get certified 366 web page provides survey contractors with access to online tutorials that will train, test and certify them to conduct traffic data collection project jobs safely and accurately. The training tutorials may be provided using a third party software system, such as Litmos™.

From the project jobs 369 web page, the contractor may access an auctions 370 web page, a my auctions 371 web page, an open 372 web page, a completed 373 web page and a disputes 374 web page. The auctions 370 web page contains all active project job auctions posted by employers. The survey contractor may search all auctions, add a project to a watch list, and view details of any data collection jobs auctions that they are certified for through the auctions 370 web page. The survey contractor may also submit an hourly rate bid to be awarded these data collection project jobs, and may change their bid before the auction expires.

The my auctions 371 web page contains all project auctions that the contractor has bid on or put on their watch-list. The survey contractor may receive a message confirming whether they were awarded a project job.

The open 372 web page contains all jobs that the survey contractor has been awarded but has not yet started. The page provides details of the awarded jobs. As well, on the open 372 web page, the survey contractor may approve or reject project job change order requests made by employer (for example, additional data requests, survey date, recounts). The survey contractor can approve project change orders (i.e. recount, data change, additional data request) to resolve issues with the employer or proceed to the dispute resolution process by submitting a dispute request form. Also, the survey contractor may send and receive messages from the employer and other survey contractors awarded to the project that are necessary to manage the projects. The messages may be linked to the project's ID. Finally, the survey contractor may dispute any project job.

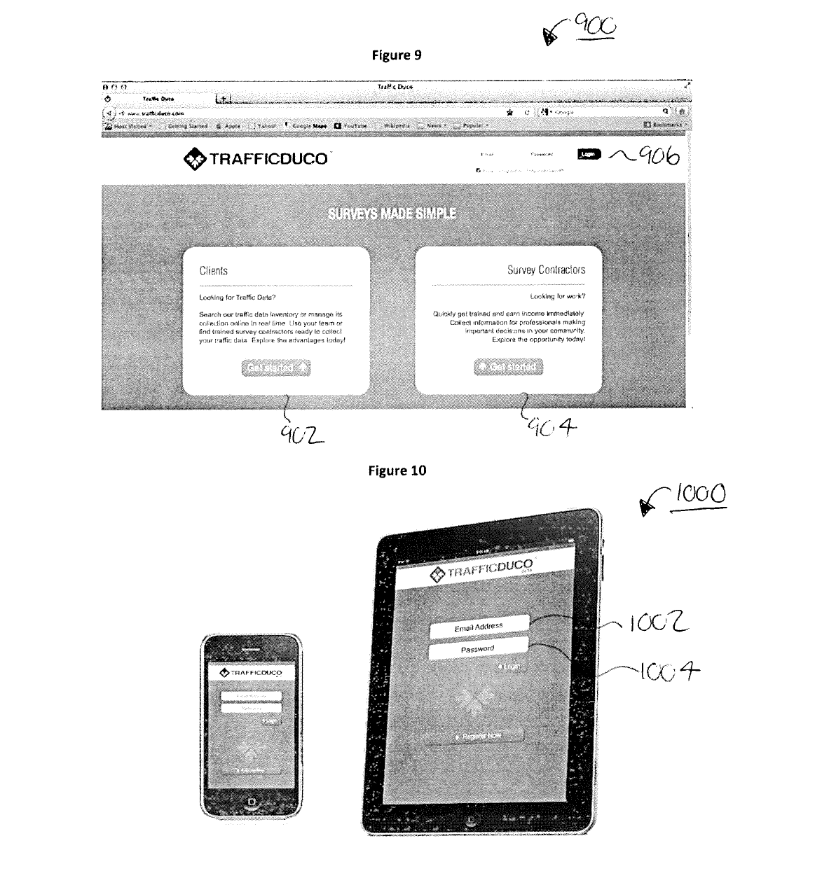

As well, survey contractors can use their own device 220, such as a touch screen mobile device, to download software applications from the software module 440, which may be necessary to conduct traffic data collection project jobs during the awarded open project job. The touch screen mobile device software application may be authenticated with the server 230, using the contractor portal 361 username and password. The software module 440 may transmit via the communication network 205 setup details to the touch screen mobile device application. FIG. 10 illustrates an example login GUI screen 1000 of the mobile device software application. The contractor may login using an email address 1002 and a password 1004.

The completed 373 web page contains all jobs that the contractor has completed successfully. The survey contractor may view details of the completed project jobs, but may not download the project data. As well, the survey contractor may provide feedback on an employer after the project job is complete, and receive payment through the payment module 430.

The disputed 374 web page contains all project jobs that are currently under temporary dispute. On the disputed 374 web page, the survey contractor may view details of the dispute, submit a dispute explanation form and edit the dispute explanation. The employer will also be able to dispute any project jobs if they cannot resolve issues with a survey contractor.

In some embodiments, in addition to the employer portal 331 and the survey contractor portal 361, there is a team portal (not shown). The team portal is similar to the survey contractor portal 361, but without the auction, my auction and disputed web pages. The team portal, which may be accessed by internal surveyor staff that are part of a team, has a team projects web page in which the internal surveyor staff may be able to accept jobs from their team. The team portal may not have access to any auction jobs for the contractors.

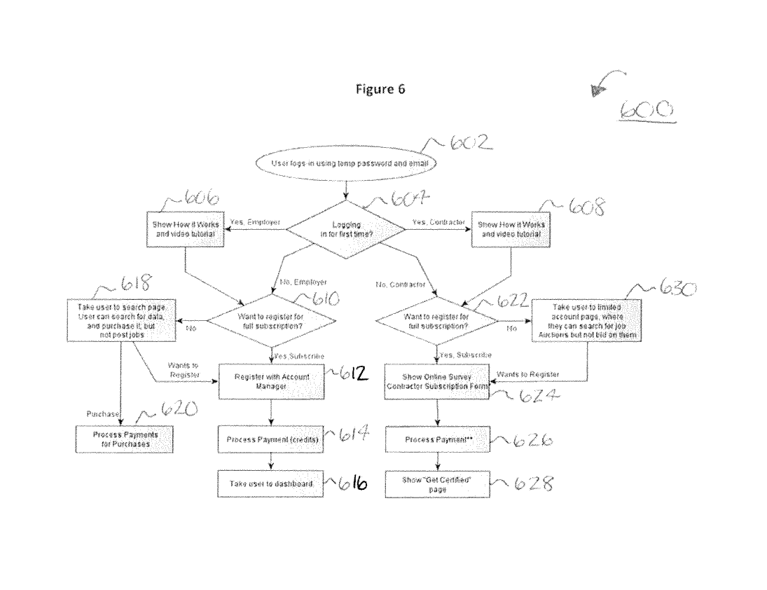

FIG. 7 illustrates an entire project process 700, from the perspective of an employer, in accordance with one embodiment of the present application. After an employer has registered as a full user, the employer may access a project post page (not shown) from the projects 339 web page (block 702). The employer completes the project posting form (block 704) and confirms the project set-up details in order to post a new data collection project for auction. The project details may include identifying the type of survey contractor (teach user, preferred contractors, all contractors) required. After completing the project auction set-up (block 708), the system 200 determines whether the employer has sufficient pre-paid credits to post the auction (block 710). If the employer does not have sufficient credits, the employer may purchase credits (block 712) to complete the transaction. From either blocks 710 or 712, the data module 420 then stores the project in the database (block 714). The submitted project is then displayed on the employer's auction 341 web page (block 716), where the employer may view details of the project, including whether there are any bids submitted by contractors (block 718). If there are no bids, the employer can edit the project auction to change dates, such as the end date and/or increase starting bids (block 720). Once a contractor bid has been submitted and the project has been awarded to a contractor (block 722), the project will be displayed on the open 342 web page (block 724). In some embodiments, a confirmation email is sent to the employer, which may be viewed on the messages 338 web page. On the open 342 web page, the employer may request a change order (block 726) prior to the contractor completing the project. On the scheduled project survey day, the one or more survey contractors awarded the project collect the traffic data and transmit the data via the communications network 205 to the data module 420 (block 728). The employer may then receive and review the submitted traffic data on the open 342 web page (block 730). After reviewing the traffic data, the employer may accept the data, reject the data with a resolution offer to the contractor, or reject the data and file a dispute.

If the data is accepted, the employer may complete a displayed feedback form about the contractor (not shown) and may have the option of adding the contractor to a preferred list (block 732). As well, after accepting the data, the contractor is compensated for the work completed (block 738). At this time the employer may specify a resale price for the project data and may confirm other specifications regarding the data that is for sale (block 740). The project is then moved to the completed 343 web page (block 742). On the completed 343 web page, the employer may view details, repost the project and download data of their completed and purchased projects (block 744).

If the data is not accepted, the employer may provide a resolution offer after rejecting the data. For example, the employer may submit a change order request for additional data (i.e. pictures etc), to change dates and/or to request recounts with compensation (block 734). If the contractor accepts the changes, the contractor will complete the amended project requirements by collecting and transmitting the new traffic data to the data module 420 (block 728). The employer may then review this new data (block 730).

If the data is rejected, the employer may submit a dispute through the disputed 344 web page. The employer may complete a displayed dispute resolution form (not shown) and may indicate if they wish to re-post the project (block 736). Once the dispute has been submitted, the entire project is moved to the disputed 344 web page (block 746). From the disputes 344 web page, the employer may view details of their project job disputes, re-post project jobs or terminate project jobs. An account manager may review the submitted disputes and may provide dispute resolution between the parties (block 748). The dispute resolution remedy or result may be recorded by the account manager through a displayed feedback form (not shown) (block 750).

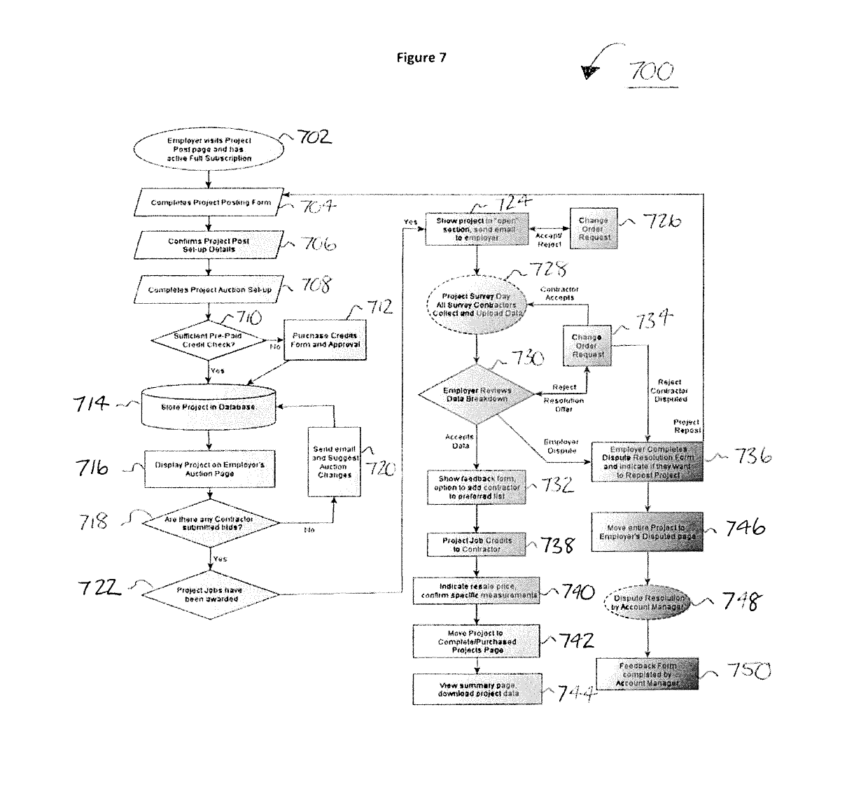

FIG. 8 illustrates an entire project job process 800, from the perspective of a survey contractor, in accordance with one embodiment of the present application. After a survey contractor has registered as a full user, the survey contractor may access the auction 370 web page from the projects 369 web page (block 802).

On the auction 370 web page, the survey contractor may search and view summary information for active project job auctions, and may also view more detailed information about a particular project (block 804). In an embodiment, the survey contractor may select an active project job auction to be added to a watch list, that may be displayed on the my auctions 371 web page. Once the survey contractor has identified an active project job auction of interest, the survey contractor may submit a bid, such as an hourly rate bid, to obtain the project job (block 806). If the submitted bid is not the lowest bid (block 808), the system 200 may notify the survey contractor of this through the messages 368 web page. The survey contractor may then change their hid before the job auction expires. Any project job auction that the survey contractor has submitted a bid for will be displayed in the my auctions 371 web page (block 810).

If by the end of the auction, the survey contractor has submitted the lowest bid and the auction has the highest priority preference (as defined by the survey contractor) for that survey date (block 812), the survey contractor is awarded the project job. If this criteria is not satisfied (block 812), the survey contractor is not awarded the project job and may receive a confirmation that they did not receive the job through the messages 368 web page or by receiving an email message (block 814).

Once the project job is awarded to the survey contractor, the survey contractor will receive a confirmation message through the message 368 web page or by receiving an email message (block 816). As well, the project job will then be posted on the open 372 web page (block 816). The survey contractor may receive a reminder message through the messages 368 web page or an email message the day before the first job start date (block 820).

Prior to the start date of the project job, the survey contractor may approve or reject job change order requests made by the employer (block 818). As well, during the period of the awarded open project job, the survey contractor may connect the mobile device application to the software module 440 of the data management web portal 400 after providing an authentication ID. The software module 440 may transmit software setup details to the mobile device application. Also, while the project job is open, the survey contractor may send and receive messages from the employer and/or other survey contractors awarded to the project through the messages 368 web page.

On the project survey day, the one or more survey contractors collect traffic data by manual user input on the surveyor device 220 and transmit the data to the data module 420 (block 822). The survey contractor may connect to the data module via communications network 205 to upload the traffic data. For example, soon after completing the collection of the traffic data, the survey contractor may send the traffic data on-site over a wireless network.

The survey contractor may view on the open 372 web page whether the employer, after receiving and reviewing the submitted traffic data (block 824) has approved the traffic data. The employer may accept the data, reject the data with a resolution offer to the survey contractor, or reject the data and file a dispute.

If the data is accepted, the survey contractor may complete a displayed feedback form about the employer (not shown) (block 826). As well, after accepting the data, the contractor is compensated for the work completed (block 828). The project job is then moved to the completed 373 web page (block 830). On the completed 373 web page, the survey contractor may view details of completed jobs, but may not download information relating to the completed job.

If the data is not accepted, the employer may provide a resolution offer after rejecting the data. For example, the employer may submit a change order request for additional data (i.e. pictures etc), to change dates and/or to request recounts with compensation (block 832). If the contractor accepts the changes, the contractor will complete the amended project requirements by collecting and transmitting the new traffic data to the data module 420 (block 822). The employer may then review this new data (block 824).

If the data is rejected, the employer may submit a dispute through the disputed 344 web page. The survey contractor may complete and edit a displayed dispute resolution form (not shown), providing an explanation of the dispute (block 834). Once the dispute has been submitted, the project job is moved to the disputed 374 web page (block 836). From the disputes 374 web page, the survey contractor may view details of their project job disputes. An account manager (i.e., an external party) may review the submitted disputes and may provide dispute resolution between the parties (block 838). The dispute resolution remedy or result may be recorded by the account manager through a displayed feedback form (not shown) (block 840).

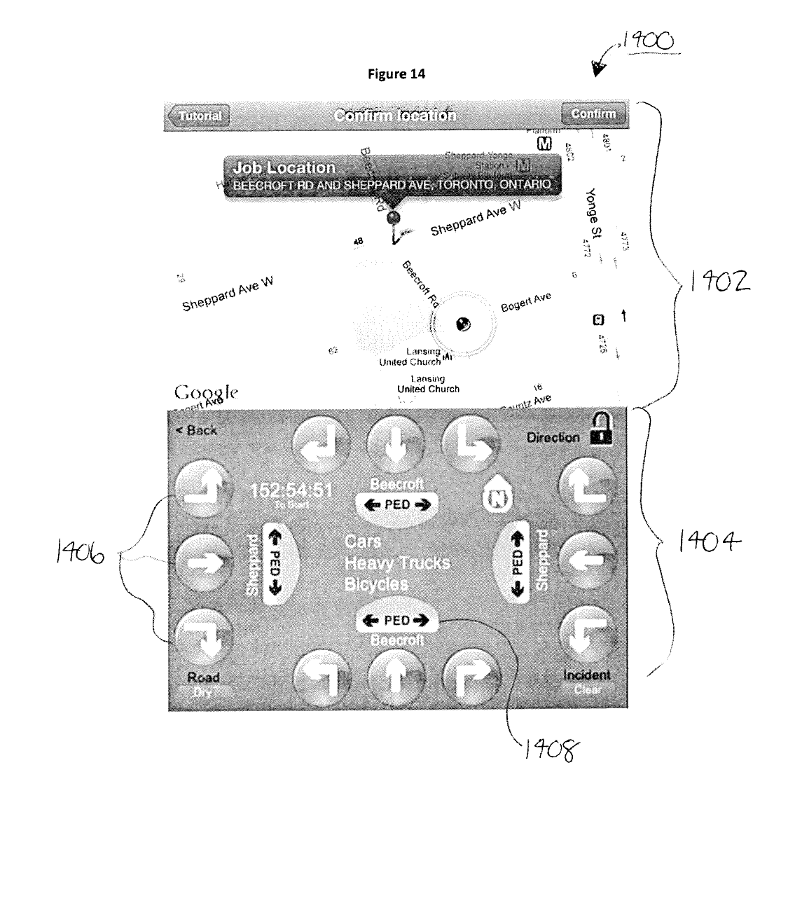

When a project job is marked as open for both the employer and the survey contractors, the following actions may take place. For example, when the survey contractor logs in through the touch screen mobile device application on the surveyor's device 220, the application will pull the data for the relevant project job. Data pulled may include all data collection setup details (e.g., time periods, location of the count, classifications to count etc.). As well, manual data collection from the touch screen mobile device can only be uploaded directly to the data module 420 of the system 200 and the summary cannot be viewed or downloaded from the touch screen mobile device. FIG. 14 illustrates an example GUI screen 1400 for the touch screen mobile device collection application. The top portion 1402 of the GUI screen 1400 provides a map view of the current job location. The bottom portion of the GUI screen 1400 provides a touch screen interface 1404 of the intersection being surveyed for the survey contractor to manually input traffic data. The survey contractor may press on the arrow buttons 1406 to count a vehicle (motorized or non-motorized) that is passing through the intersection. As well, the touch screen interface 1404 provides arrow buttons 1408 to count pedestrian traffic (e.g., people crossing the road on foot).

Also, while the traffic data collection project is taking place, the mobile device application will push the comma-separated values (csv) data file to the data module 420, and store it in the relevant section of the database. When each data collection project time period has ended and confirmed by the survey contractor, completion details will be uploaded to the data module 420. If an employer has a question or comment, they can post it from the open project 342 web page and this will be shown on the open 372 project web page for the survey contractor in real time. It will also show up on the touch screen mobile device application on the surveyor's device 220.

Once all project time periods are complete and survey contractor user indicates from the touch screen mobile device application that the count is complete, the project job data should be marked as uploaded in the system database and remain in the open 372 project web page until the job is accepted by the employer.

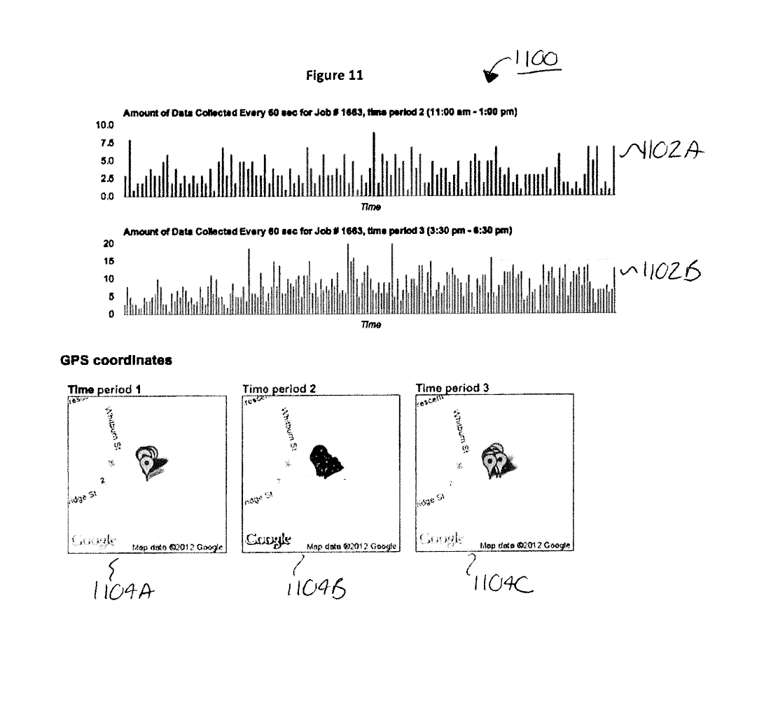

FIG. 11 shows relevant verification statistics of the uploaded data that the Employer can approve, dispute or request a change order (recount). FIG. 11 shows an example data information GUI screen 1100, showing the verification statistics regarding the collected project data. As shown, the GUI screen 1100 may show statistics 1102A and 1102B regarding the amount of data collected every minute for a particular time period. As well, the GUI screen 110 may present GPS information 1104A, 1104B, and 1104C regarding where the project data was collected for a particular time period.

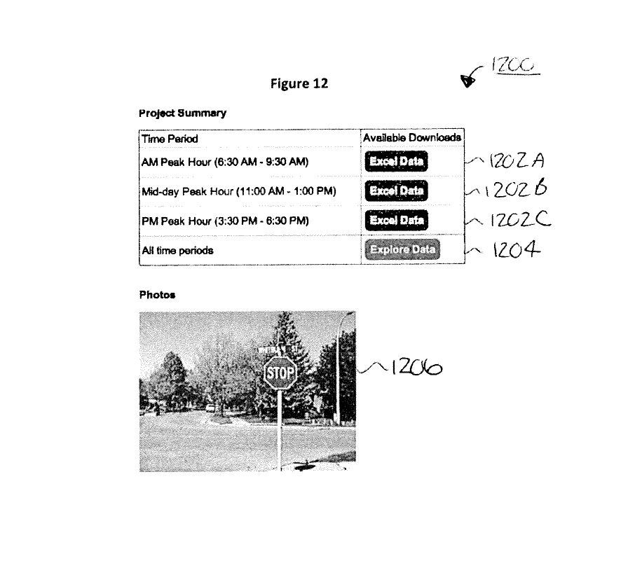

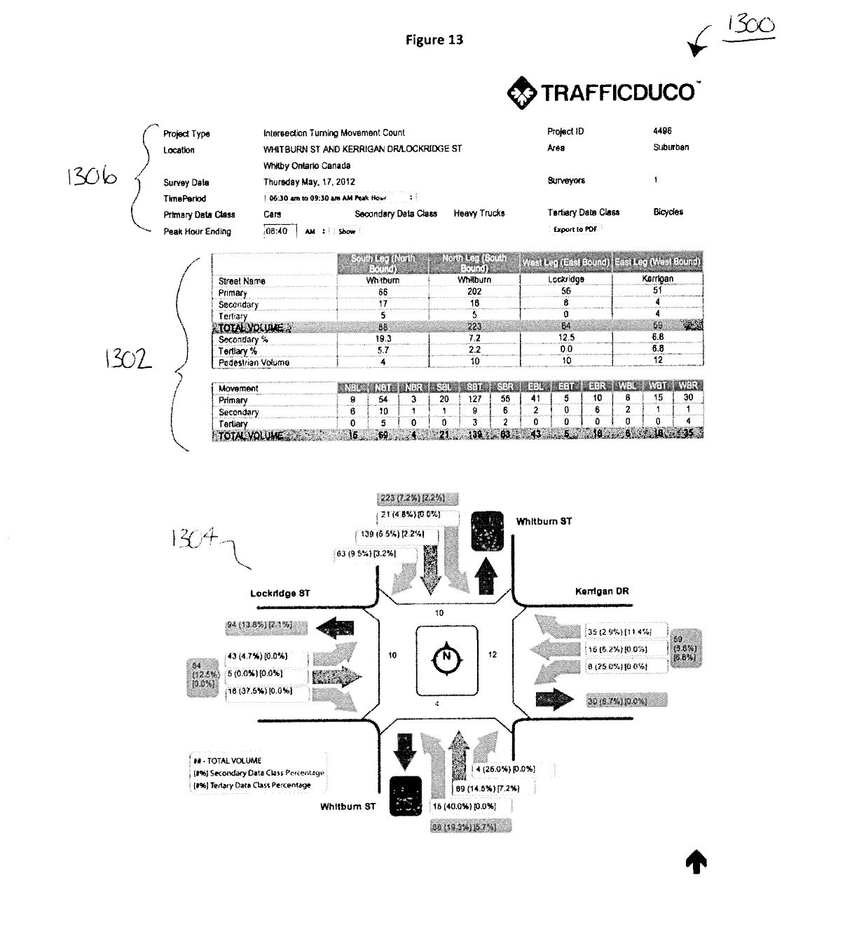

FIG. 12 shows an example project summary GUI screen 1200, showing a summary of the project and providing downloadable project data. As illustrated, the files containing project data 1202A, 1202B and 1202C is available to be downloaded by the employer for each time period of the project. As well, the project data for the entire time period may be downloaded in file 1204. The project summary GUI screen 1200 may also provide an image 1206, such as a photograph, of the intersection surveyed in the project. FIG. 13 shows an example project data GUI screen 1300, showing the detailed project data information and relevant statistics. As illustrated, the statistics may be presented in a chart 1302 or graphical image 1304. As well, the information 1306 relating to the project is presented, such as project ID, project type, location, survey date, time period, data classes, and number of survey contractors.

If the data is approved, the project prepaid credits (or other form of payment) are released to the survey contractor as compensation. All project jobs will need to be approved before proceeding to the project summary to register a resale price, view summary and download all project data. The project will then be marked complete and viewed in the completed page.

If the data is disputed, the entire project will be moved to the dispute page and follow predetermined dispute resolution process and policies. If a change order request is submitted by the employer, all the survey contractors on the project will need to approve the recount request. If the request is approved, the project will remain in the open project page. The new recounted data may replace any original data files for that project.

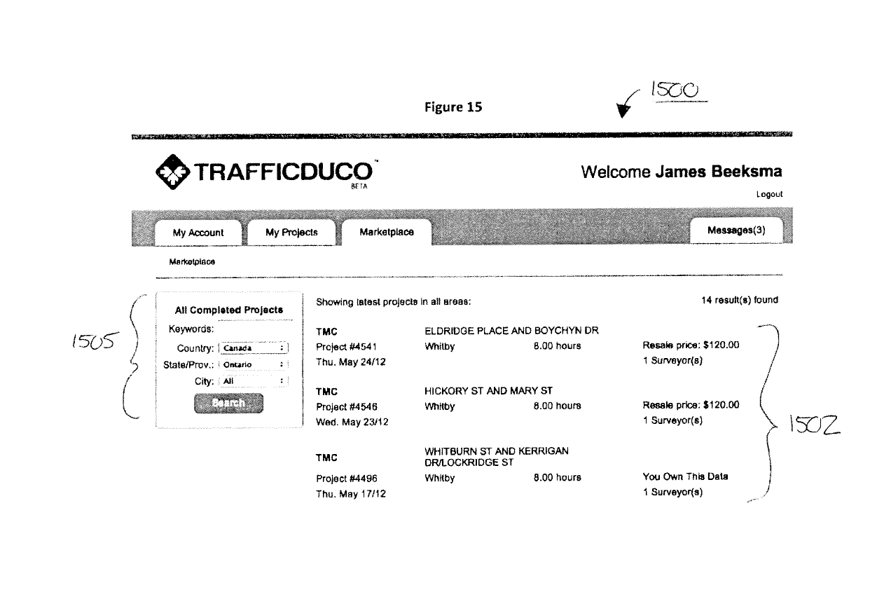

When the entire project is approved by the employer as being complete, the employer can choose to keep the project data private or set a price to sell the project data in the data module 420 in the marketplace which can be accessed through the search database web page to all employers, where the employers may purchase the project data at the resale price submitted by the original employer. FIG. 15 shows an example marketplace GUI screen 1500 illustrating a listing 1502 of project data for sale. Each project entry provides information about the project, such as location, project number, date of completion, time spent completing the project, number of survey contractors and the resale price to purchase the project data. As well, the marketplace GUI screen 1500 provides a search form 1505, allowing a registered employer to search for completed project data based on the location of the project, such as city, state/province, and country, and based on inputted keywords.

The scope of the claims should not be limited by the embodiments set forth in the examples, but should be given the broadest interpretation consistent with the description as a whole.

Having thus described the invention, it is now claimed:

1. A method for data management, the method comprising:
generating, from a server, for display on a graphical interface screen a data management portal providing a web service to view traffic data collection project jobs, view project traffic data, and sell project traffic data;
sending, at the server, traffic data collection project setup information to an electronic device via a communication network;
receiving, at the server, traffic data from the electronic device via the communication network; and
storing the received traffic data in a database.

2. The method for data management of claim 1, wherein the communication network is a wireless network.

3. The method for data management of claim 1, further comprising:
processing, through the data management portal, a purchase of project traffic data and transmitting the project traffic data to another electronic device.

4. The method for data management of claim 1, further comprising:
authenticating a user for accessing the data management portal.

5. The method for data management of claim 1, further comprising:
processing, through the data management portal, the received traffic data comprising determining at least one of: count, survey recording, direction, global positioning system (GPS) location and time.

6. The method for data management of claim 1, further comprising:
merging, through the data management portal, the received traffic data from two or more electronic devices into a single data project.

7. A computer system, comprising:
a processor;
a memory for storing project data; and
a communications subsystem;
the processor being configured to:
generate for display on a graphical interface screen a data management portal providing a web service to view traffic data collection project jobs, view project traffic data, and sell project traffic data;
send traffic data collection project setup information to an electronic device via a communication network;
receive traffic data from the electronic device via the communication network; and
store the received traffic data in a database.

8. The computer system of claim 7, wherein the processor is further configured to facilitate the purchase of the stored traffic data.

9. The computer system of claim 7, wherein the processor is further configured to authenticate a user for accessing the data management portal website.

10. The computer system of claim 7, wherein the processor is further configured to process the received traffic data, comprising determining at least one of: count, survey recording, direction, global positioning system (GPS) location and time.

11. The computer system of claim 7, wherein the processor is further configured to merge the received traffic data from two or more electronic devices into a single data project.

12. The computer system of claim 7, wherein the data management portal comprises a contractor portal and an employer portal.

13. The computer system of claim 12, wherein the contractor portal facilitates searching the traffic data collection project jobs, bidding on the traffic collection project jobs and receiving payment for completing the traffic collection project jobs.

14. The computer system of claim 12, wherein the employer portal facilitates searching project traffic data, buying project traffic data, selling project traffic data and posting a traffic data collection project job.

15. The computer system of claim 12, wherein the employer portal facilitates viewing traffic data collected for a traffic collection project job.

16. The computer system of claim 12, wherein the employer portal webpage and the contractor portal webpage facilitate communication between data management portal users.

17. An electronic device, comprising:
a processor;
a memory for storing project data; and
a communications subsystem;
the processor being configured to:
generate, on a web browser, for display on a graphical interface screen a data management portal providing a web service to search traffic data collection project jobs, bid on traffic data collection project jobs, and receive payment for completed traffic data collection project jobs;
receive, from a computer system, data collection setup information for a data collection application via a communication network; and
transmit traffic data to the computer system via the communication network.

18. The electronic device of claim 17, wherein the processor is further configured to:
generate for display on the graphical interface screen the data collection application, and receive, through the data collection application, user inputted traffic data.

19. The electronic device of claim 7, wherein the electronic device is a touch screen mobile device.

20. A non-transitory computer readable medium having instructions stored thereon, which when executed by a processor for facilitating data management, the processor performs the method of claim 1.
